(19) United States
(12) Patent Application Publication
(10) Pub. No.: US 2015/0031249 A1
(43) Pub. Date: Jan. 29, 2015

(54) POWER CONNECTOR AND POWER CONTACT THEREOF WITH IMPROVED SUPPORT MEMBER FOR SUPPORTING ENGAGING ARM

(71) Applicant: ALLTOP ELECTRONICS (SUZHOU) LTD., Taicang City (CN)

(72) Inventors: Wang-I YU, Jhonghe City (TW); Hung-Chi TAI, Jhonghe City (TW); Yung-Chih HUNG, Jhonghe City (TW)

(73) Assignee: ALLTOP ELECTRONICS (SUZHOU) LTD., Taicang City (CN)

(21) Appl. No.: 14/073,204

(22) Filed: Nov. 6, 2013

(30) Foreign Application Priority Data
Jul. 25, 2013 (CN) CN 201310315792.7

(51) Int. Cl. H01R 13/193

(52) U.S. Cl. CPC H01R 13/193
USPC 439/733.1; 439/839

(57) ABSTRACT

A power contact includes a fixing portion, an engaging arm extending backwardly from a front end of the fixing portion along a first direction and a support member extending towards the engaging arm. The support member is positioned between the engaging arm and the fixing portion along a second direction perpendicular to the first direction. The support member is adapted for abutting against the engaging arm so as to increase insertion/withdraw force and avoid over deformation of the engaging arm.

### BACKGROUND OF THE INVENTION

1. Field of the Invention

The present invention relates to a power connector and a power contact thereof, and more particularly to a power connector and a power contact thereof with an improved support member for supporting an engaging arm.

2. Description of Related Art

With rapid development of electronic technologies, power connectors have been widely used in electronic devices for power supply. A conventional power connector usually includes an insulative housing and a plurality of power contacts received in the insulative housing. Each power contact includes a soldering portion extending beyond the insulative housing for being mounted to a circuit board. A connector assembly including a plug power connector and a receptacle power connector for mating with the plug power connector is usually applied in the electronic devices.

In order to meet the requirements of stable signal transmission and high effective transmission of the electronic devices, strong mating stabilization of the power connectors need to be ensured. However, contacting arms of conventional receptacle power connectors are short and are provided with limited deformation scope. Under this condition, when plug contacts of large thickness are inserted thereinto, the contacting arms of the conventional receptacle power connectors may occur permanent deformation which will damage the receptacle power connector.

Hence, it is desirable to provide an improved power connector and a power contact thereof to solve the above problems.

### BRIEF SUMMARY OF THE INVENTION

The present invention provides a power connector including an insulative housing and a plurality of power contacts fixed to the insulative housing. Each power contact includes a fixing portion, an engaging arm extending backwardly from a front end of the fixing portion along a first direction, and a support member formed on the fixing portion and extending towards the engaging arm. The support member is positioned between the engaging arm and the fixing portion along a second direction perpendicular to the first direction. The support member is adapted for abutting against the engaging arm so as to increase insertion/withdraw force and avoid over deformation of the engaging arm.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The components in the drawing are not necessarily drawn to scale, the emphasis instead being placed upon clearly illustrating the principles of the described embodiments. In the drawings, reference numerals designate corresponding parts throughout various views, and all the views are schematic.

FIG. 1 is a perspective view of a power connector and a complementary plug in accordance with an illustrated embodiment of the present invention;

FIG. 2 is a perspective view of the power connector as shown in FIG. 1;

FIG. 3 is an exploded view of the power connector as shown in FIG. 2;

FIG. 4 is a perspective view of an insulative housing of the power connector as shown in FIG. 3;

FIG. 5 is another perspective view of the insulative housing as shown in FIG. 4;

FIG. 6 is a perspective view of a power contact according to a first illustrated embodiment;

FIG. 7 is another perspective view of the power contact taken from a different aspect; and

FIG. 8 is a perspective view of a power contact according to a second illustrated embodiment.

### DETAILED DESCRIPTION OF THE PREFERRED EMBODIMENTS

Reference will now be made to the drawing figures to describe the embodiments of the present invention in detail. In the following description, the same drawing reference numerals are used for the same elements in different drawings.

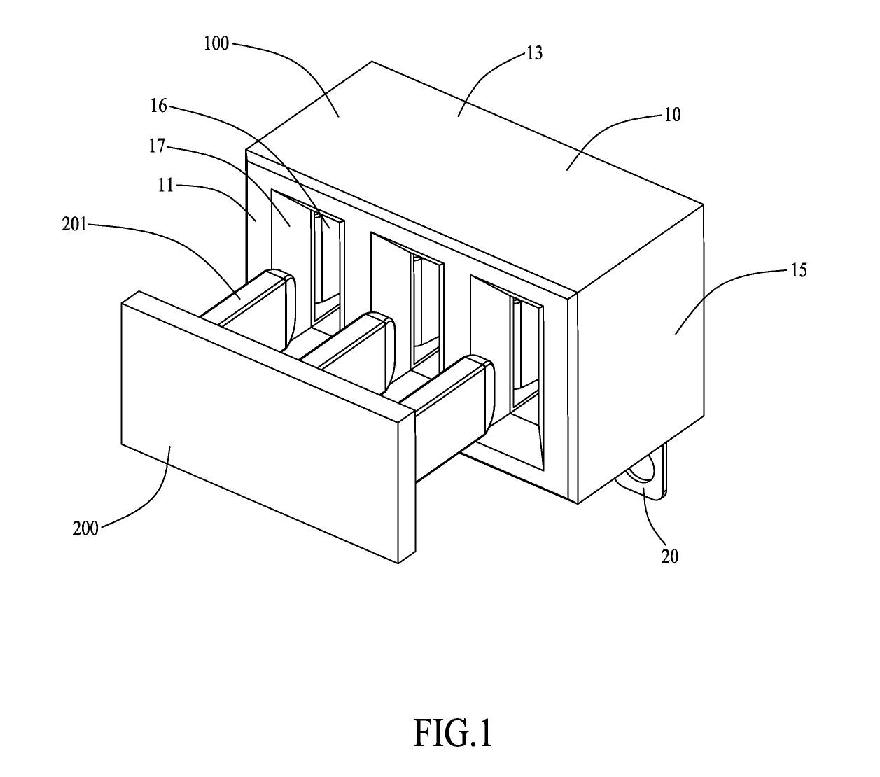

Referring to FIG. 1, the present invention discloses a power connector 100 for being mounted to a circuit board (not shown) to receive a complementary plug 200. The power connector 100 includes an insulative housing 10 and a plurality of power contacts 20 retained in the insulative housing 10 for mating with contacts 201 of the complementary plug 200.

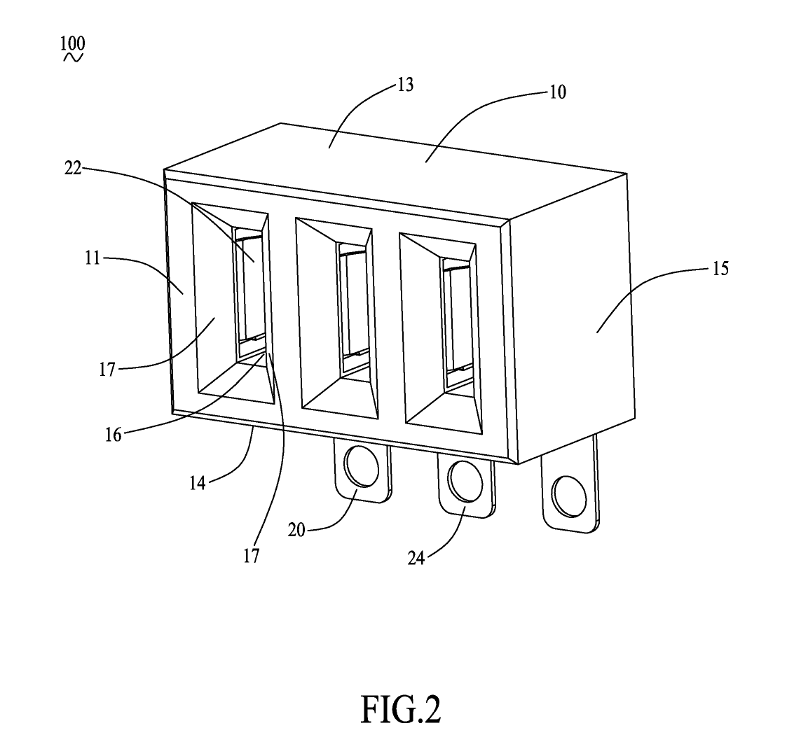

Referring to FIGS. 2 to 5, the insulative housing 10 includes a front surface 11, a rear surface 12 opposite to the front surface 11 and four peripheral walls between the front surface 11 and the rear surface 12. The four peripheral walls includes a top wall 13, a bottom wall 14 opposite to the top wall 13, and a pair of side walls 15 connecting the top wall 13 and the bottom wall 14.

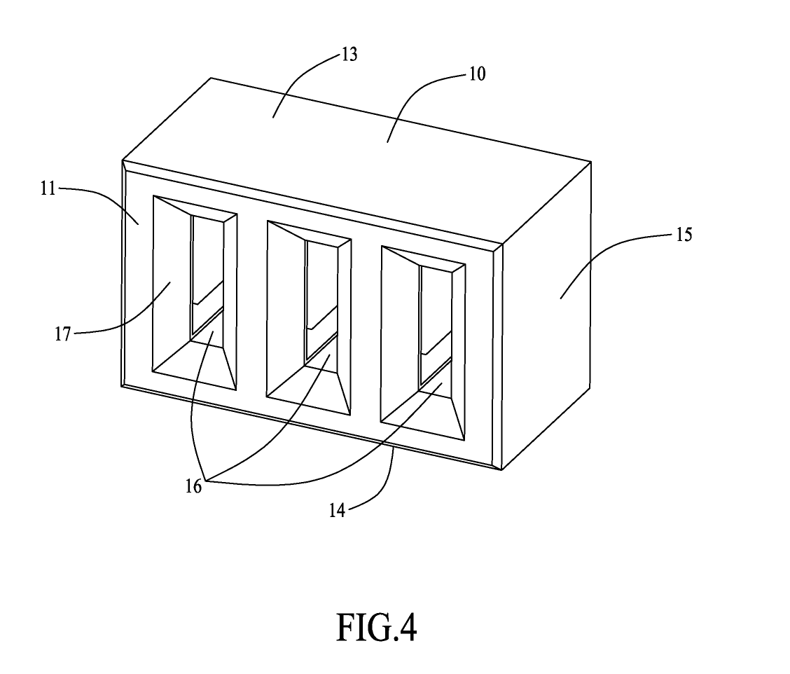

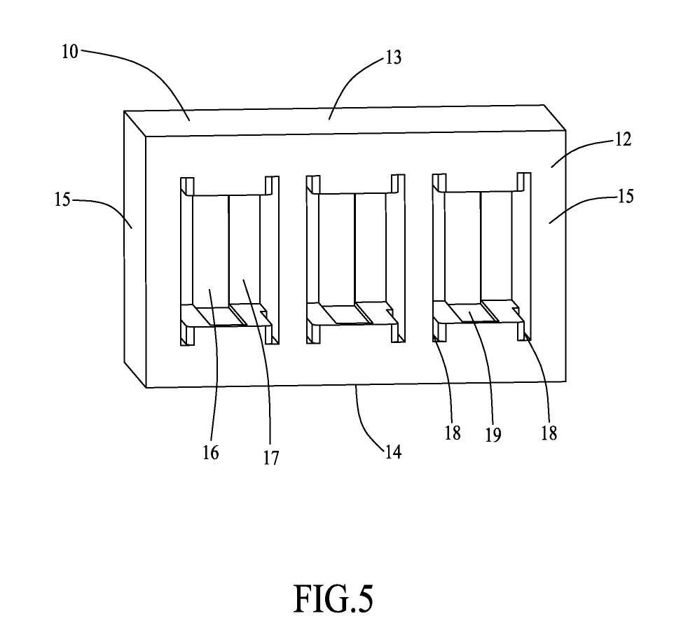

Referring to FIGS. 4 and 5, the insulative housing 10 includes a plurality of rectangular chambers 16 extending through the front surface 11 and the rear surface 12 for accommodating the power contacts 20. The insulative housing 10 includes a plurality of slots 18 extending through the rear surface 12. The slots 18 are divided into three pairs each of which are in communication with corresponding chamber 16. Besides, each pair of slots 18 are located at lateral sides of the corresponding chamber 16. In addition, a plurality of restricting slots 19 are formed on a top side of the bottom wall 14. Each restricting slot 19 is in communication with the corresponding chamber 16 for positioning the complementary plug 200 when it is inserted into the chambers 16. The insulative housing 10 includes a pair of inclined stop walls 17 located adjacent to the front surface 11. The stop walls 17 protruding into the chambers 16 for positioning the power contacts 20 when the power contacts 20 are assembled into the insulative housing 10 from the rear surface 12. Besides, the inclined stop walls 17 are adapted for guiding insertion of the complementary plug 200. A distance between the pair of stop walls 17 in each chamber 16 is equal to a width of the restricting slot 19 as a result that the complementary plug 200 can be well regulated when it is inserted into the power connector 100.

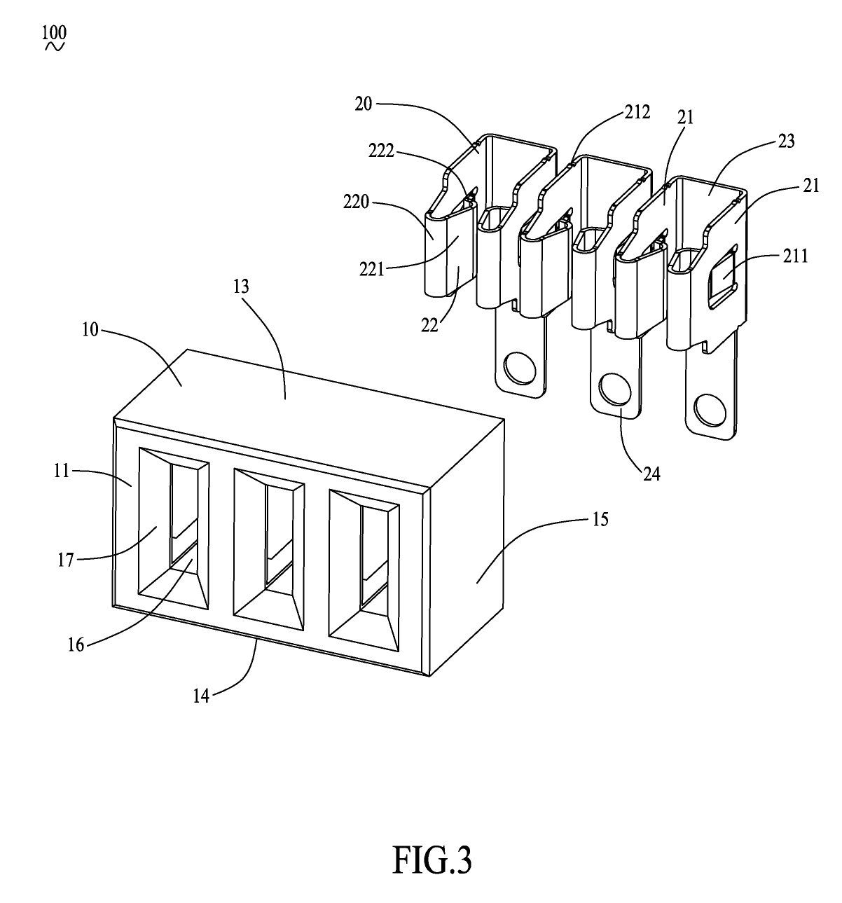

Referring to FIGS. 3, 6 and 7, according to a first illustrated embodiment of the present invention, each power contact 20 is essential of a symmetrical configuration and includes a pair of parallel fixing portions 21 fixed in the slots 18, a pair of engaging arms 22 extending backwardly from front ends 220 of the fixing portions 21 along a first direction (i.e., a front-to-back direction), a connecting beam 23 connecting the fixing portions 21 and a soldering portion 24 extending downwardly from the connecting beam 24 for being soldered to a circuit board. Since each power contact 20 is symmetrical along a vertical plane (not shown) centrally extending through the connecting beam 23, only the fixing portion 21 and the engaging arm 22 located at the same side will be described in detail hereinafter.

The fixing portion 21 includes a support member 211 formed thereon and extending towards the engaging arm 22 in such a manner that the support member 211 is positioned between the engaging arm 22 and the fixing portion 21 along a second direction (i.e., a left to right direction) perpendicular to the first direction. The fixing portion 21 is wider than the engaging arm 22 measured along a third direction (i.e., a vertical direction) perpendicular to the first direction and the second direction for secure fixation. The support member 211 is adapted for abutting against the engaging arm 22 so as to increase insertion/withdraw force and avoid over deformation of the engaging arm 22.

According to the illustrated embodiments of the present invention, the support member 211 is a resilient arm stamped from the fixing portion 21. The resilient arm 211 and the engaging arm 22 extend essentially along opposite directions in the first direction, wherein the resilient arm 211 extends along a rear-to-front direction while the engaging arm 22 extends along a front-to-rear direction. The resilient arm 211 is narrower than the engaging arm 22 measured along the third direction for easy manufacture. The resilient arm 211 is a cantilevered arm which includes an engaging portion 2111 at a distal end thereof for abutting against the engaging arm 22.

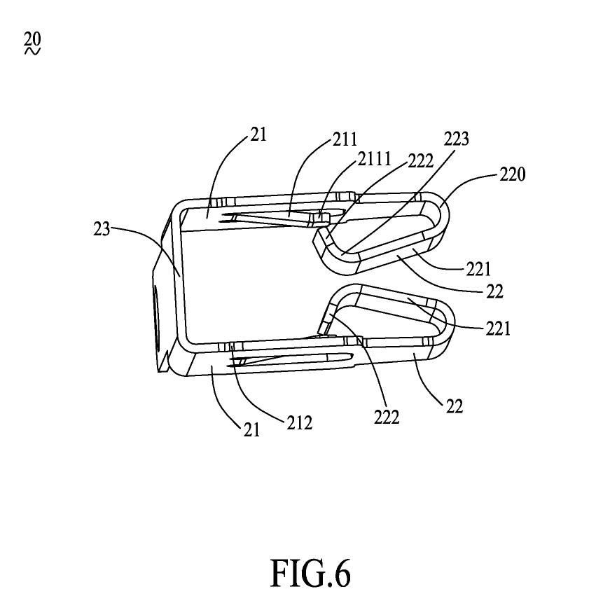

The engaging arm 22 includes a front arm 221 slantwise extending away from the fixing portion 21, a rear arm 222 bent towards the fixing portion 21 and a contact portion 223 formed at a boundary of the front arm 221 and the rear arm 222 for mating with the contact 201 of the complementary plug 200. As shown in FIG. 6, the engaging portion 2111 of the support member 211 is positioned between the rear arm 222 and the fixing portion 21 along the second direction. A gap is formed between the engaging portion 2111 and the rear arm 222 along the second direction. The engaging portion 2111 is adapted for abutting against the rear arm 222 so as to increase insertion/withdraw force and avoid over deformation of the engaging arm 22.

The fixing portion 21 includes a plurality barbs 212 rigidly abutting against an inner side of the slot 18 for secure fixation. The front end 220 of the fixing portion 21 from which the engaging arm 22 is restricted by and located behind the stop wall 17. The engaging arm 22 protrudes into the chamber 16 for mating with the complementary plug 200.

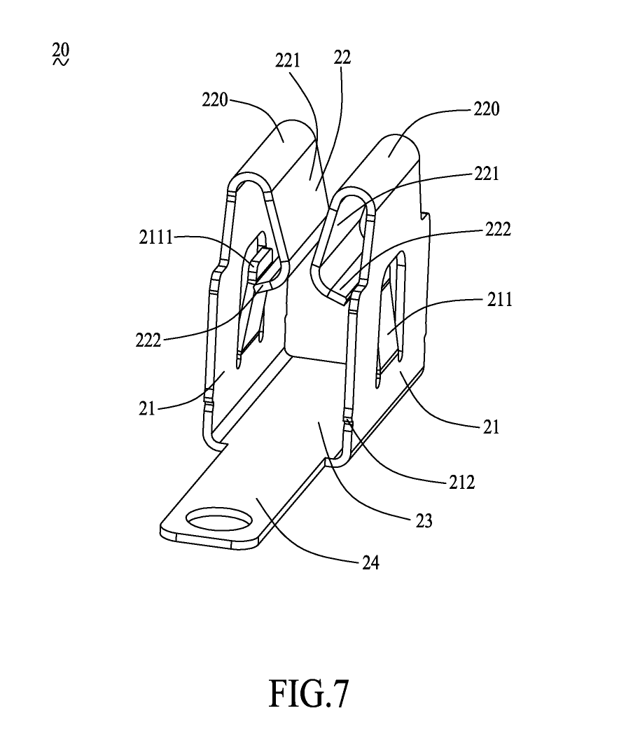

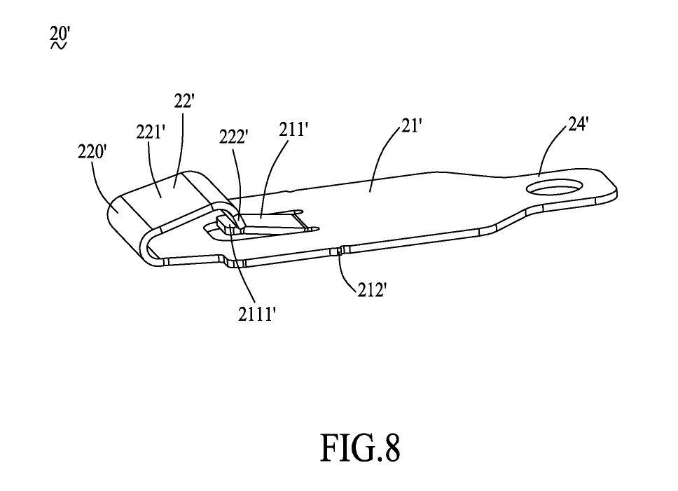

Referring to FIGS. 3 and 8, according to a second illustrated embodiment of the present invention, each power contact 20′ is substantially a half of the power contact 20 illustrated in the first embodiment. The same numerals in the first and the second illustrated embodiments represent the same configurations. For example, the fixing portion 21′, the engaging arm 22′, the support member 211′ and related features of the power contact 20′ are the same as those of the power contact 20. The main differences between them are that the power contact 20′ is not provided with a connecting beam 23 shown in FIG. 7, and each power contact 20′ includes a soldering portion 24′ extending from the fixing portion 21′ along the first direction. The soldering portion 24′ and the fixing portion 21′ are coplanar with each other.

It is understandable that a single power contact 20 illustrated in the first embodiment is corresponding to receive a single contact 201 of the complementary plug 200, while a pair of the power contacts 20′ are required for cooperatively receiving a single contact 201 of the complementary plug 200.

When the complementary plug 200 is inserted into the power connector 100, if each contact 201 of the complementary plug 200 is of small thickness, a little deformation of each engaging arm 22 occurs. Under this condition, the engaging portion 2111 will not abut against the rear arm 222 so as to realize small insertion/withdraw force. However, if the contact 201 of the complementary plug 200 is of large thickness, great deformation of each engaging arm 22 occurs. Under this condition, the engaging portion 2111 will abut against the rear arm 222 to increase insertion/withdraw force and avoid over deformation of the engaging arm 22. The configurations of the power contacts 20, 20′ of the illustrated embodiments of the present invention are of excellent compatibility and are suitable for wide applications.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present disclosure to the full extent indicated by the broadest general meaning of the terms in which the appended claims are expressed.

What is claimed is:

1. A power contact comprising:
a fixing portion;
an engaging arm extending backwardly from a front end of the fixing portion along a first direction; and
a support member formed on the fixing portion and extending towards the engaging arm in such a manner that the support member is positioned between the engaging arm and the fixing portion along a second direction perpendicular to the first direction; wherein
the support member is adapted for abutting against the engaging arm so as to increase insertion/withdraw force and avoid over deformation of the engaging arm.

2. The power contact as claimed in claim 1, wherein the support member comprises a resilient arm stamped from the fixing portion, the resilient arm and the engaging arm extending essentially along opposite directions in the first direction.

3. The power contact as claimed in claim 2, wherein the fixing portion is wider than the engaging arm measured along a third direction perpendicular to the first direction and the second direction, and the engaging arm is also wider than the resilient arm along the third direction.

4. The power contact as claimed in claim 2, wherein the engaging arm comprises a front arm extending away from the fixing portion, a rear arm bent towards the fixing portion and a contact portion formed at a boundary of the front arm and the rear arm.

5. The power contact as claimed in claim 4, wherein the resilient arm is a cantilevered arm having an engaging portion at a distal end thereof, the engaging portion being positioned between the rear arm and the fixing portion, the engaging portion being adapted for abutting against the rear arm so as to increase insertion/withdraw force and avoid over deformation of the engaging arm.

6. The power contact as claimed in claim 1, further comprising a soldering portion extending from the fixing portion along the first direction.

7. The power contact as claimed in claim 1, wherein the power contact is of a symmetrical configuration and comprises a pair of the fixing portions, a pair of the engaging arms, a pair of the support members and a connecting beam connecting the fixing portions.

8. The power contact as claimed in claim 7, further comprising a soldering portion extending downwardly from the connecting beam.

9. A power contact essentially of a symmetrical configuration and comprising:
a pair of fixing portions arranged in parallel relationship with each other;
a connecting beam connecting the fixing portions;
a pair of engaging arms extending backwardly from front ends of the fixing portions along a first direction, respectively; and
a pair of support members respectively formed on the fixing portions and extending towards the engaging arms in such a manner that each support member is positioned between adjacent engaging arm and adjacent fixing portion along a second direction perpendicular to the first direction; wherein
each support member is adapted for abutting against the adjacent engaging arm so as to increase insertion/withdraw force and avoid over deformation of the adjacent engaging arm.

10. The power contact as claimed in claim 9, wherein each support member comprises a resilient arm stamped from the fixing portion, the resilient arm and the engaging arm extending essentially along opposite directions in the first direction.

11. The power contact as claimed in claim 10, wherein each fixing portion is wider than the engaging arm measured along a third direction perpendicular to the first direction and the second direction, and the engaging arm is also wider than the resilient arm along the third direction.

12. The power contact as claimed in claim 10, wherein each engaging arm comprises a front arm extending away from the fixing portion, a rear arm bent towards the fixing portion and a contact portion formed at a boundary of the front arm and the rear arm, the support member being positioned between adjacent rear arm and the adjacent fixing portion.

13. The power contact as claimed in claim 12, wherein the resilient arm is a cantilevered arm having an engaging portion at a distal end thereof, the engaging portion of the support member being positioned between the adjacent rear arm and the adjacent fixing portion, the engaging portion being adapted for abutting against the adjacent rear arm so as to increase insertion/withdraw force and avoid over deformation of the engaging arm.

14. A power connector comprising:
an insulative housing comprising a front surface, a rear surface, a slot extending through the rear surface and a chamber extending through the front surface and the rear surface; and
a power contact comprising a fixing portion fixed in the slot, an engaging arm extending backwardly from a front end of the fixing portion along a first direction and a support member formed on the fixing portion, the engaging arm extending into the chamber for mating with a complementary plug, the support member being positioned between the engaging arm and the fixing portion along a second direction perpendicular to the first direction; wherein
the support member is adapted for abutting against the engaging arm so as to increase insertion/withdraw force and avoid over deformation of the engaging arm.

15. The power connector as claimed in claim 14, wherein the support member comprises a resilient arm stamped from the fixing portion, the resilient arm and the engaging arm extending essentially along opposite directions in the first direction.

16. The power connector as claimed in claim 15, wherein the fixing portion is wider than the engaging arm measured along a third direction perpendicular to the first direction and the second direction, and the engaging arm is also wider than the resilient arm along the third direction.

17. The power connector as claimed in claim 14, wherein the engaging arm comprises a front arm extending away from the fixing portion, a rear arm bent towards the fixing portion and a contact portion formed at a boundary of the front arm and the rear arm for mating with the complementary plug.

18. The power connector as claimed in claim 17, wherein the support member is positioned between the rear arm and the fixing portion along the second direction, the support member being adapted for abutting against the rear arm so as to increase insertion/withdraw force and avoid over deformation of the engaging arm.

19. The power connector as claimed in claim 14, further comprising a soldering portion extending from the fixing portion along the first direction.

20. The power connector as claimed in claim 14, wherein the power contact is of a symmetrical configuration and comprises a pair of the fixing portions, a pair of the engaging arms, a pair of the support members, a connecting beam connecting the fixing portions and a soldering portion extending downwardly from the connecting beam.
